(19) United States
(12) Patent Application Publication
(10) Pub. No.: US 2005/0223027 A1
(43) Pub. Date: Oct. 6, 2005

(54) Methods and systems for structuring event data in a database for location and retrieval

(76) Inventors: Stephen R. Lawrence, Mountain View, CA (US); Omar Habib Khan, Toronto (CA)

Correspondence Address: FENWICK & WEST LLP, SILICON VALLEY CENTER, 801 CALIFORNIA STREET, MOUNTAIN VIEW, CA, 94041, US

(21) Appl. No.: 10/815,071

(22) Filed: Mar. 31, 2004

(51) Int. Cl. G06F 7/00

(52) U.S. Cl. 707/103 R

(57) ABSTRACT

Methods and systems are provided for configuring event data representing activity within a computer, which allows that article to be more readily accessed by a search engine. In one embodiment, an event associated with an article is captured, wherein the event comprises event data, the event is indexed, a related event object is created related to the event, wherein the related event object comprises a set of one or more related events, and the related event object is associated with the one or more related events.

### RELATED APPLICATIONS

This application is related to co-pending applications Ser. No. 10/______ (Attorney Docket No. GP-175-09-US) entitled METHODS AND SYSTEMS FOR REAL TIME INDEXING IN A DATABASE FOR LOCATION AND RETRIEVAL, Ser. No. 10/______ (Attorney Docket No. GP-175-10) entitled METHODS AND SYSTEMS FOR INDEXING AND STORING DIFFERENT VERSIONS OF ARTICLES, Ser. No. 10/______ (Attorney Docket No. GP-175-11) entitled METHODS AND SYSTEMS FOR MANAGING THE STORAGE OF ARTICLES, Ser. No. 10/______ (Attorney Docket No. GP-175-30) entitled METHODS AND SYSTEMS FOR IDENTIFYING A REPRESENTATIVE IMAGE FOR AN ARTICLE, and Ser. No. 10/______(Attorney Docket No. GP-175-46) entitled METHODS AND SYSTEMS FOR SELECTIVELY STORING EVENT DATA, all of which are being filed concurrently herewith, the disclosures of which are incorporated herein by this reference.

### FIELD OF THE INVENTION

The invention relates generally to search engines for information retrieval. More particularly, the invention relates to methods and systems for structuring and storing event data in a database to facilitate information retrieval.

### BACKGROUND OF THE INVENTION

Users generate and access a large number of articles, such as emails, web pages, word processing documents, spreadsheet documents, instant messenger messages, and presentation documents, using a client device, such as a personal computer, personal digital assistant, or mobile phone. Some articles are stored on one or more storage devices coupled to, accessible by, or otherwise associated with the client device(s). Users sometimes wish to search the storage device(s) for articles.

Conventional client-device search applications may significantly degrade the performance of the client device. For example, certain conventional client-device search applications typically use batch processing to index all articles, which can result in noticeably slower performance of the client device during the batch processing. Additionally, batch processing occurs only periodically. Therefore, when a user performs a search, the most recent articles are sometimes not included in the results. Moreover, if the batch processing is scheduled for a time when the client device is not operational and is thus not performed for an extended period of time, the index of articles associated with the client device can become outdated. Conventional client-device search applications can also need to rebuild the index at each batch processing or build new partial indexes and perform a merge operation that can use a lot of client-device resources. Conventional client-device search applications also sometimes use a great deal of system resources when operational, resulting in slower performance of the client device.

Furthermore, conventional client-device search applications may perform indexing of articles such as documents and email messages by forming a separate entity for each article. Thus, when a search is initiated, the search engine may have to check each entity for a match, resulting in a time consuming, inefficient search. Conventional client-device search applications also may not distinguish between a user's interaction with articles happening in real time and occurring in the past. Additionally, conventional client-device search applications can require an explicit search query from a user to generate results, and may be limited to file names or the contents of a particular application's files.

### SUMMARY

Embodiments of methods and systems for structuring event data in a database for location and retrieval are described. In one embodiment, an event associated with an article is captured, wherein the event comprises event data, the event is indexed, a related event object is created related to the event, wherein the related event object comprises a set of one or more related events, and the related event object is associated with the one or more related events.

This exemplary embodiment is mentioned not to limit or define the invention, but to provide an example of an embodiment of the invention to aid understanding thereof. Exemplary embodiments are discussed in the Detailed Description, and further description of the invention is provided there. Advantages offered by the various embodiments of the present invention may be further understood by examining this specification.

### BRIEF DESCRIPTION OF THE DRAWINGS

These and other features, aspects, and advantages of the present invention are better understood when the following Detailed Description is read with reference to the accompanying drawings in which like numerals indicate like elements throughout the several figures, wherein:

FIG. 1 is a block diagram illustrating an exemplary environment according to one embodiment of the present invention;

FIG. 2 is a diagram of an exemplary related event object generated in response to accessing a web page and the indexed events corresponding to that web page according to one embodiment of the present invention;

FIG. 3 is a diagram of an exemplary related event object generated in response to creating and/or downloading a word processing document according to one embodiment of the present invention; and

FIG. 4 illustrates a flow diagram of an exemplary method for storing and updated events and related event object according to one embodiment of the present invention.

### DETAILED DESCRIPTION OF SPECIFIC EMBODIMENTS

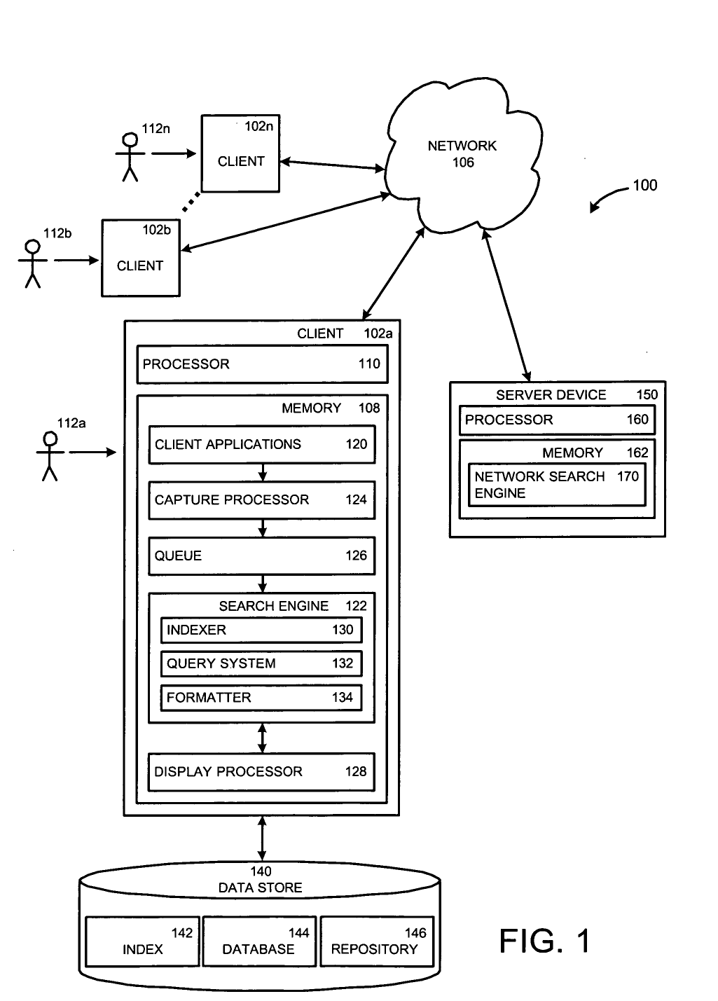

Referring now to the drawings in which like numerals indicate like elements throughout the several figures, FIG. 1 is a block diagram illustrating an exemplary environment for implementation of an embodiment of the present invention. While the environment shown in FIG. 1 reflects a client-side search engine architecture embodiment, other embodiments are possible. The system 100 shown in FIG. 1 includes multiple client devices 102a-n that can communicate with a server device 150 over a network 106. The network 106 shown in FIG. 1 comprises the Internet. In other embodiments, other networks, such as an intranet, may be used instead. Moreover, methods according to the present invention may operate within a single client device that does not communicate with a server device or a network.

The client devices 102a-n shown in FIG. 1 each includes a computer-readable medium 108. The embodiment shown in FIG. 1 includes a random access memory (RAM) 108 coupled to a processor 110. The processor 110 executes computer-executable program instructions stored in memory 108. Such processors may include a microprocessor, an ASIC, state machines, or other processor, and can be any of a number of suitable computer processors, such as processors from Intel Corporation of Santa Clara, Calif. and Motorola Corporation of Schaumburg, Ill. Such processors include, or may be in communication with, media, for example computer-readable media, which stores instructions that, when executed by the processor, cause the processor to perform the steps described herein. Embodiments of computer-readable media include, but are not limited to, an electronic, optical, magnetic, or other storage or transmission device capable of providing a processor, such as the processor 110 of client 102a, with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

Client devices 102a-n can be coupled to a network 106, or alternatively, can be stand alone machines. Client devices 102a-n may also include a number of external or internal devices such as a mouse, a CD-ROM, DVD, a keyboard, a display device, or other input or output devices. Examples of client devices 102a-n are personal computers, digital assistants, personal digital assistants, cellular phones, mobile phones, smart phones, pagers, digital tablets, laptop computers, Internet appliances, and other processor-based devices. In general, the client devices 102a-n may be any type of processor-based platform that operates on any suitable operating system, such as Microsoft® Windows® or Linux, capable of supporting one or more client application programs. For example, the client device 102a can comprise a personal computer executing client application programs, also known as client applications 120. The client applications 120 can be contained in memory 108 and can include, for example, a word processing application, a spreadsheet application, an email application, an instant messenger application, a presentation application, an Internet browser application, a calendar/organizer application, a video playing application, an audio playing application, an image display application, a file management program, an operating system shell, and other applications capable of being executed by a client device. Client applications may also include client-side application that interact with or access other applications (such as, for example, a web-browser executing on the client device 102a that interacts with a remote email server to access email).

The user 112a can interact with the various client applications 120 and articles associated with the client applications 120 via various input and output devices of the client device 102a. Articles include, for example, word processor documents, spreadsheet documents, presentation documents, emails, instant messenger messages, database entries, calendar entries, appointment entries, task manager entries, source code files, and other client application program content, files, messages, items, web pages of various formats, such as HTML, XML, XHTML, Portable Document Format (PDF) files, and media files, such as image files, audio files, and video files, or any other documents or items or groups of documents or items or information of any suitable type whatsoever.

The user's 112a interaction with articles, the client applications 120, and the client device 102a creates event data that may be observed, recorded, analyzed or otherwise used. An event can be any occurrence possible associated with an article, client application 120, or client device 102a, such as inputting text in an article, displaying an article on a display device, sending an article, receiving an article, manipulating an input device, opening an article, saving an article, printing an article, closing an article, opening a client application program, closing a client application program, idle time, processor load, disk access, memory usage, bringing a client application program to the foreground, changing visual display details of the application (such as resizing or minimizing) and any other suitable occurrence associated with an article, a client application program, or the client device whatsoever. Additionally, event data can be generated when the client device 102a interacts with an article independent of the user 112a, such as when receiving an email or performing a scheduled task.

The memory 108 of the client device 102a can also contain a capture processor 124, a queue 126, and a search engine 122. The client device 102a can also contain or is in communication with a data store 140. The capture processor 124 can capture events and pass them to the queue 126. The queue 126 can pass the captured events to the search engine 122 or the search engine 122 can retrieve new events from the queue 126. In one embodiment, the queue 126 notifies the search engine 122 when a new event arrives in the queue 126 and the search engine 122 retrieves the event (or events) from the queue 126 when the search engine 122 is ready to process the event (or events). When the search engine receives an event it can be processed and can be stored in the data store 140. The search engine 122 can receive an explicit query from the user 112a or generate an implicit query and it can retrieve information from the data store 140 in response to the query. In another embodiment, the queue is located in the search engine 122. In still another embodiment, the client device 102a does not have a queue and the events are passed from the capture processor 124 directly to the search engine 122. According to other embodiments, the event data is transferred using an information exchange protocol. The information exchange protocol can comprise, for example, any suitable rule or convention facilitating data exchange, and can include, for example, any one of the following communication mechanisms: Extensible Markup Language—Remote Procedure Calling protocol (XML/RPC), Hypertext Transfer Protocol (HTTP), Simple Object Access Protocol (SOAP), shared memory, sockets, local or remote procedure calling, or any other suitable information exchange mechanism.

The capture processor 124 can capture an event by identifying and compiling event data associated with an event. Examples of events include sending or receiving an instant messenger message, a user viewing a web page, saving a word processing document, printing a spreadsheet document, inputting text to compose or edit an email, opening a presentation application, closing an instant messenger application, entering a keystroke, moving the mouse, and hovering the mouse over a hyperlink. An example of event data captured by the capture processor 124 for an event involving the viewing of a web page by a user can comprise the URL of the web page, the time and date the user viewed the web page, the content of the web page in original or processed forms, a screenshot of the page as displayed to the user, and a thumbnail version of the screenshot.

In the embodiment shown in FIG. 1, the capture processor 124 comprises multiple capture components. For example, the capture processor 124 shown in FIG. 1 comprises a separate capture component for each client application in order to capture events associated with each application. The capture processor 124 can also comprises a separate capture component that monitors overall network activity in order to capture event data associated with network activity, such as the receipt or sending of an instant messenger message. The capture processor 124 shown in FIG. 1 also can comprise a separate client device capture component that monitors overall client device performance data, such as processor load, idle time, disk access, the client applications in use, and the amount of memory available. The capture processor 124 shown in FIG. 1 also comprises a separate capture component to monitor and capture keystrokes input by the user and a separate capture component to monitor and capture items, such as text, displayed on a display device associated with the client device 102a. An individual capture component can monitor multiple client applications and multiple capture components can monitor different aspects of a single client application.

In one embodiment, the capture processor 124, through the individual capture components, can monitor activity on the client device and can capture events by a generalized event definition and registration mechanism, such as an event schema. Each capture component can define its own event schema or can use a predefined one. Event schemas can differ depending on the client application or activity the capture component is monitoring. Generally, the event schema can describe the format for an event, for example, by providing fields for event data associated with the event (such as the time of the event) and fields related to any associated article (such as the title) as well as the content of any associated article (such as the document body). An event schema can describe the format for any suitable event data that relates to an event. For example, an event schema for an email message event received by the user 112a can include the sender, the recipient or list of recipients, the time sent, the date sent, and the content of the message. An event schema for a web page currently being viewed by a user can include the Uniform Resource Locator (URL) of the web page, the time being viewed, and the content of the web page. An event schema for a word processing document being saved by a user can include the title of the document, the time saved, the format of the document, the text of the document, and the location of the document. More generally, an event schema can describe the state of the system around the time of the event. For example, an event schema can contain a URL for a web page event associated with a previous web page that the user navigated from. In addition, event schema can describe fields with more complicated structure like lists. For example, an event schema can contain fields that list multiple recipients. An event schema can also contain optional fields so that an application can include additional event data if desired.

The capture processor 124 can capture events occurring presently (or “real-time events”) and can capture events that have occurred in the past (or “historical events”). Real-time events can be “indexable” or “non-indexable”. In one embodiment, the search engine 122 indexes indexable real-time events, but does not index non-indexable real-time events. The search engine 122 may determine whether to index an event based on the importance of the event or a capture score associated with and/or determined for the event. Indexable real-time events can be more important events associated with an article, such as viewing a web page, loading or saving a file, and receiving or sending an instant message or email. Non-indexable events can be deemed not important enough by the search engine 122 to index and store the event, such as moving the mouse or selecting a portion of text in an article. Non-indexable events can be used by the search engine 122 to update the current user state. While all real-time events can relate to what the user is currently doing (or the current user state), indexable real-time events can be indexed and stored in the data store 140. Alternatively, the search engine 122 can index all real-time events. Real-time events can include, for example, sending or receiving an article, such as an instant messenger message, examining a portion of an article, such as selecting a portion of text or moving a mouse over a portion of a web page, changing an article, such as typing a word in an email or pasting a sentence in a word processing document, closing an article, such as closing an instant messenger window or changing an email message being viewed, loading, saving, opening, or viewing an article, such as a word processing document, web page, or email, listening to or saving an MP3 file or other audio/video file, or updating the metadata of an article, such as book marking a web page, printing a presentation document, deleting a word processing document, or moving a spreadsheet document.

Historical events are similar to indexable real-time events except that the event occurred before the installation of the search engine 122 or was otherwise not captured, because, for example, the search engine 122 was not operational for a period of time while the client device 102a was operational or because no capture component existed for a specific type of historical event at the time the event took place. Examples of historical events include the user's saved word processing documents, media files, presentation documents, calendar entries, and spreadsheet documents, the emails in a user's inbox, and the web pages book marked by the user. The capture processor 124 can capture historical events by periodically crawling the memory 108 and any associated data storage device for events not previously captured by the capture processor 124. The capture processor 124 can also capture historical events by requesting certain client applications, such as a web browser or an email application, to retrieve articles and other associated information. For example, the capture processor 124 can request that the web browser application obtain all viewed web pages by the user or request that the email application obtain all email messages associated with the user. These articles may not currently exist in memory 108 or on a storage device of the client device 102a. For example, the email application may have to retrieve emails from a server device. In one embodiment, the search engine 122 indexes historical events.

Generally, more information may be determined for real-time events. For example, when a user saves a word processing document creating a real-time event, it can be known that the user was working on the document and this can be reflected in the event data for the event. For a historical event for a word processing document generated by crawling a storage device associated with the client-device, it may not be known whether the user has ever viewed the word processing document. In another example, when a real-time event is generated for a user viewing or accessing a web page, event data associated with the event may contain duration and activity information, such as how long the user viewed the page, whether the user scrolled down the page, and the amount of scrolling activity associated with the page. This information can be reflected in the event data for the event. For a historical event for a web page generated by crawling a cache associated with a web browser, duration and activity information may not be available.

In the embodiment shown in FIG. 1, events captured by the capture processor 124 are sent to the queue 126 in the format described by an event schema. The capture processor 124 can also send performance data to the queue 126. Examples of performance data include current processor load, average processor load over a predetermined period of time, idle time, disk access, the client applications in use, and the amount of memory available. Performance data can also be provided by specific performance monitoring components, some of which may be part of the search engine 122, for example. The performance data in the queue 126 can be retrieved by the search engine 122 and the capture components of the capture processor 124. For example, capture components can retrieve the performance data to alter how many events are sent to the queue 126 or how detailed the events are that are sent (fewer or smaller events when the system is busy) or how frequently events are sent (events are sent less often when the system is busy or there are too many events waiting to be processed). The search engine 122 can use performance data to determine when it indexes various events and when and how often it issues implicit queries.

In one embodiment, the queue 126 holds events until the search engine 122 is ready to process an event or events. Alternatively, the queue 126 uses the performance data to help determine how quickly to provide the events to the search engine 122. The queue 126 can comprise one or more separate queues including a user state queue and an index queue. The index queue can queue indexable events, for example. Alternatively, the queue 126 can have additional queues or comprise a single queue. The queue 126 can be implemented as a circular priority queue using memory mapped files. The queue can be a multiple-priority queue where higher priority events are served before lower priority events, and other components may be able to specify the type of events they are interested in. Generally, real-time events can be given higher priority than historical events, and indexable events can be given higher priority than non-indexable real-time events. Other implementations of the queue 126 are possible. In another embodiment, the client device 102a does not have a queue 126. In this embodiment, events are passed directly from the capture processor 124 to the search engine 122. In other embodiments, events can be transferred between the capture components and the search engine using suitable information exchange mechanisms such as: Extensible Markup Language—Remote Procedure Calling protocol (XML/RPC), Hypertext Transfer Protocol (HTTP), Simple Object Access Protocol (SOAP), shared memory, sockets, local or remote procedure calling, or any other suitable information exchange mechanism.

The search engine 122 can contain an indexer 130, a query system 132, and a formatter 134. The query system 132 can retrieve real-time events and performance data from the queue 126. The query system 132 can use performance data and real-time events to update the current user state and generate an implicit query. An implicit query can be an automatically generated query based on the current user state. The query system 132 can also receive and process explicit queries from the user 112a. Performance data can also be retrieved by the search engine 122 from the queue 126 for use in determining the amount of activity possible by the search engine 122.

In the embodiment shown in FIG. 1, indexable real-time events and historical events (indexable events) are retrieved from the queue 126 by the indexer 130. Alternatively, the queue 126 may send the indexable events to the indexer 130. In one embodiment, for example, real-time events may be retrieved and processed by the indexer 130 in small batches and historical events may be retrieved and processed by the indexer 130 in larger batches of, for example, 100 or more events. By processing real-time events in small batches, real-time events can be indexed close in time to the occurrence and capture of the event and may be available for searching more quickly. The indexer 130 can index the indexable events and can send them to the data store 140 where they are stored. The data store 140 can be any type of computer-readable media and can be integrated with the client device 102a, such as a hard drive, or external to the client device 102a, such as an external hard drive or on another data storage device accessed through the network 106. The data store 140 can be one or more logical or physical storage areas. In one embodiment, the data store 140 can be in memory 108. The data store 140 may facilitate one or a combination of methods for storing data, including without limitation, arrays, hash tables, lists, and pairs, and may include compression and encryption. In the embodiment shown in FIG. 1, the data store comprises an index 142, a database 144 and a repository 146.

In the embodiment shown in FIG. 1, when the indexer 130 receives an event, the indexer 130 can determine, from the event schema, terms (if any) associated with the event, the time of the event (if available), images (if any) associated with the event, and any other information defining the event. The indexer 130 can also determine if the event relates to other events and associate the event with related events. Related events can be associated with each other in a related event object, which can be stored in the data store 140. For example, for an event concerning a web page, the indexer 130 can associate this event with other events concerning the same web page. This association information can be stored in database 133 in a related event object for each group of related events. The indexer 130 can send and incorporate the terms and times, associated with the event in the index 142 of the data store 140. The event can be sent to the database 144 for storage and the content of the associated article and any associated images can be stored in the repository 146.

In the embodiment shown in FIG. 1, a user 112a can input an explicit query into a search engine interface displayed on the client device 102a, which is received by the search engine 122. The search engine 122 can also generate an implicit query based on a current user state, which can be determined by the query system 132 from real-time events. Based on the query, the query system 132 can locate relevant information in the data store 140 and provide a result set. In one embodiment, the result set comprises article identifiers for articles associated with the client applications 120 or client articles. Client articles include articles associated with the user 112a or client device 102a, such as the user's emails, word processing documents, instant messenger messages, previously viewed web pages and any other article or portion of an article associated with the client device 102a or user 112a. An article identifier may be, for example, a Uniform Resource Locator (URL), a file name, a link, an icon, a path for a local file, or other suitable information that may identify an article. A result set can contain articles associated with real-time events and historical events. In one embodiment, articles associated with real-time events can be ranked higher than articles associated with historical events. In another embodiment, the result set also can comprise article identifiers for articles located on the network 106 or network articles located by a search engine on a server device. Network articles can include articles located on the network 106 not previously viewed or otherwise referenced by the user 112a, such as web pages not previously viewed by the user 112a.

The formatter 134 can receive the search result set from the query system 132 of the search engine 122 and can format the results for output to a display processor 128. In one embodiment, the formatter 134 can format the results in XML, HTML, or tab delineated text. The display processor 128 can be contained in memory 108 and can control the display of the result set on a display device associated with the client device 102a. The display processor 128 may comprise various components. For example, in one embodiment, the display processor 128 comprises a Hypertext Transfer Protocol (HTTP) server that receives requests for information and responds by constructing and transmitting Hypertext Markup Language (HTML) pages. In one such embodiment, the HTTP server comprises a scaled-down version of the Apache Web server. The display processor 128 can be associated with a set of APIs to allow various applications to receive the results and display them in various formats. The display APIs can be implemented in various ways, including as, for example, DLL exports, COM interface, VB, JAVA, or NET libraries, or a web service.

Through the client devices 102a-n, users 112a-n can communicate over the network 106, with each other and with other systems and devices coupled to the network 106. As shown in FIG. 1, a server device 150 can be coupled to the network 106. In the embodiment shown in FIG. 1, the search engine 122 can transmit a search query comprised of an explicit or implicit query or both to the server device 150. The user 112a can also enter a search query in a search engine interface, which can be transmitted to the server device 150 by the client device 102a via the network 106. In another embodiment, the query signal may instead be sent to a proxy server (not shown), which then transmits the query signal to server device 150. Other configurations are also possible.

The server device 150 can include a server executing a search engine application program, such as the Google™ search engine. In other embodiments, the server device 150 can comprise a related information server or an advertising server. Similar to the client devices 102a-n, the server device 150 can include a processor 160 coupled to a computer-readable memory 162. Server device 150, depicted as a single computer system, may be implemented as a network of computer processors. Examples of a server device 150 are servers, mainframe computers, networked computers, a processor-based device, and similar types of systems and devices. The server processor 160 can be any of a number of computer processors, such as processors from Intel Corporation of Santa Clara, Calif. and Motorola Corporation of Schaumburg, Ill. In another embodiment, the server device 150 may exist on a client-device. In still another embodiment, there can be multiple server devices 150.

Memory 162 contains the search engine application program, also known as a network search engine 170. The search engine 170 can locate relevant information from the network 106 in response to a search query from a client device 102a. The search engine 170 then can provide a result set to the client device 102a via the network 106. The result set can comprise one or more article identifiers. An article identifier may be, for example, a Uniform Resource Locator (URL), a file name, a link, an icon, a path for a local file, or anything else that identifies an article. In one embodiment, an article identifier can comprise a URL associated with an article.

In one embodiment, the server device 150, or related device, has previously performed a crawl of the network 106 to locate articles, such as web pages, stored at other devices or systems coupled to the network 106, and indexed the articles in memory 162 or on another data storage device. It should be appreciated that other methods for indexing articles in lieu of or in combination with crawling may be used, such as manual submission.

As previously described above, events can be categorized as indexable events and non-indexable events. Rather than using conventional indexing techniques and indexing events as independent objects in the database 144, the search engine 122 may associate an event with related events. In one embodiment, a related event object is used to associate the related events. Table 1 below illustrates, for various event types, an example of an associated Related Event Object ID (in this example Uniform Resource Identifier (URI)) and the corresponding related event object contents.

TABLE 1

| | | Related Event Object |
|---|---|---|
| Event Type | Related Event ID = URI | Contents |
| web page | http://www.cnn.com | all accesses to given |
| | | URL |
| Microsoft | file://c:/Documents | all load, save, print |
| Office ® | | events associated with |
| | | a given word |
| | | processing document |
| email | googleemail://thread_name | all email in a given |
| | | thread |
| instant | googleim://conversation_identifier | all instant messages |
| messaging | | in a given conversation |

The related event object contents can be a set or list of associated events plus related event object data such as article title, location, article type, time of last viewing, frequency of viewing and size. The related event object contents can be stored in the database 144. In one embodiment, a few select sentences can be stored to assist in the generation of a snippet for search results. The snippet may be, for example, excerpted text from a word processing file, or the subject line or names of the sender(s) and/or recipient(s) in an email thread. The related event object can be used by the database and query system for performing searches. A second level related events object can also be used to associate related events objects. In one embodiment, multiple levels of related events objects may be use.

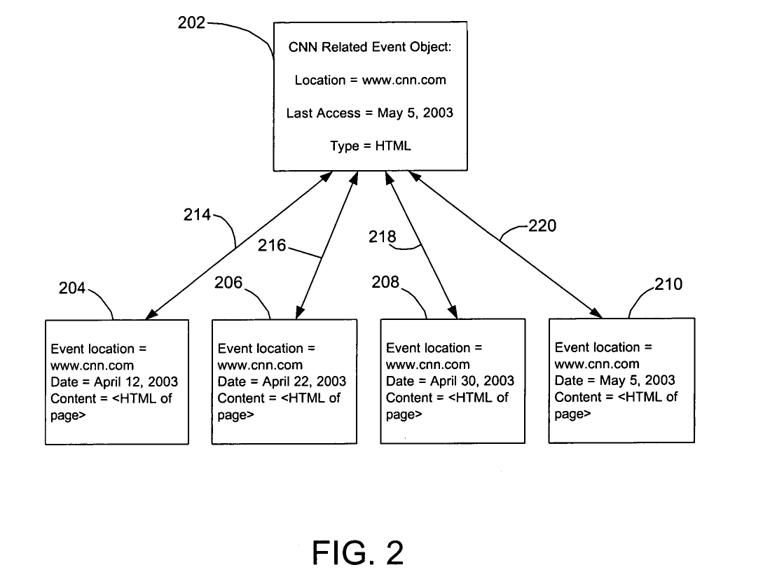

FIG. 2 is a diagram of an exemplary related event object generated in response to accessing a web page and the indexed events corresponding to that web page according to one embodiment of the present invention. In this example, the web page is for CNN® at www.cnn.com. For this example, there is only one related event object 202 associated with this web page. The related event object contents as illustrated in FIG. 2 include the Related Event Object ID, such as, for example, a URL associated with the web page, the date of last access, and the native format, such as, for example, HTML. When a user visits the CNN® web page, an event can be generated and indexed. In the illustrated example of FIG. 2, there are four events 204, 206, 208, 210 that are indexed in conjunction with the related event object 202. The choice of four events is for ease of illustration only. As will be readily apparent to those in the art, the number of events associated with a given related event object may be smaller or larger and possibly unlimited.

Each event may have a unique identifier, such as an Event ID, associated with it. In this example, each event differs in the date of access and the content of the web page. Other differences and similarities may be present. The Event ID can be derived from the time of indexing, which occurs as events are taken off of the queue 126. For purposes of this example, the reference numerals 204, 206, 208 and 210 provide the unique Event IDs. Related event object 202 stores a set or list of the Event IDs for 204, 206, 208 and 210 to permit a quick determination of all events associated with the web page. Further, each event 204, 206, 208 and 210 has a corresponding pointer 214, 216, 218, 220, respectively, to the unique related event object 202. Thus, given one event, e.g., event 206, for the CNN web page, a search can quickly identify the related event object 202 associated with that event, which in turn can provide access to related events associated with the CNN web site.

Related events objects may also exist for the web pages within a web site or specific URLs within specific websites, such as www.cnn.com/technology and www.cnn.com/technology/space. For this case, a second level related events object can be used to refer to www.cnn.com and may point to the related objects for the web pages within a web site or specific URLs within specific websites, such as www.cnn.com/technology and www.cnn.com/technology/space.

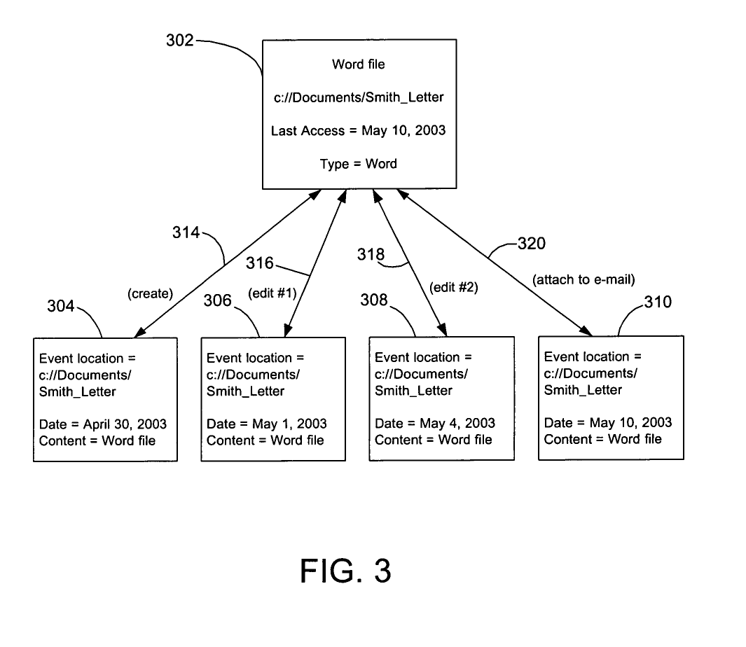

FIG. 3 is a diagram of an exemplary related event object generated in response to creating and/or downloading a word processing document according to one embodiment of the present invention. In this example, a related event object 302 is shown corresponding to a word processing document (or file), in this case, a letter to John Smith created using a word processing application, such as Microsoft Word®. Events 304, 306, 308 and 310 correspond to different steps in the creation (304) and editing (306, 308) of the letter, and then the letter is attached to an email for transmission (310). Pointers 314, 316, 318, 320 corresponding to each event 304, 306, 308 and 310, respectively, point to related event object 302. In one embodiment, another pointer or pointers can be used to point to the email event related to the email message transmitting the letter and/or to point to a related events object associated with the email message. A second level related events object for articles, such as files or documents, may refer to a specific directory where related documents are stored, such as My Documents/work/2003/12.

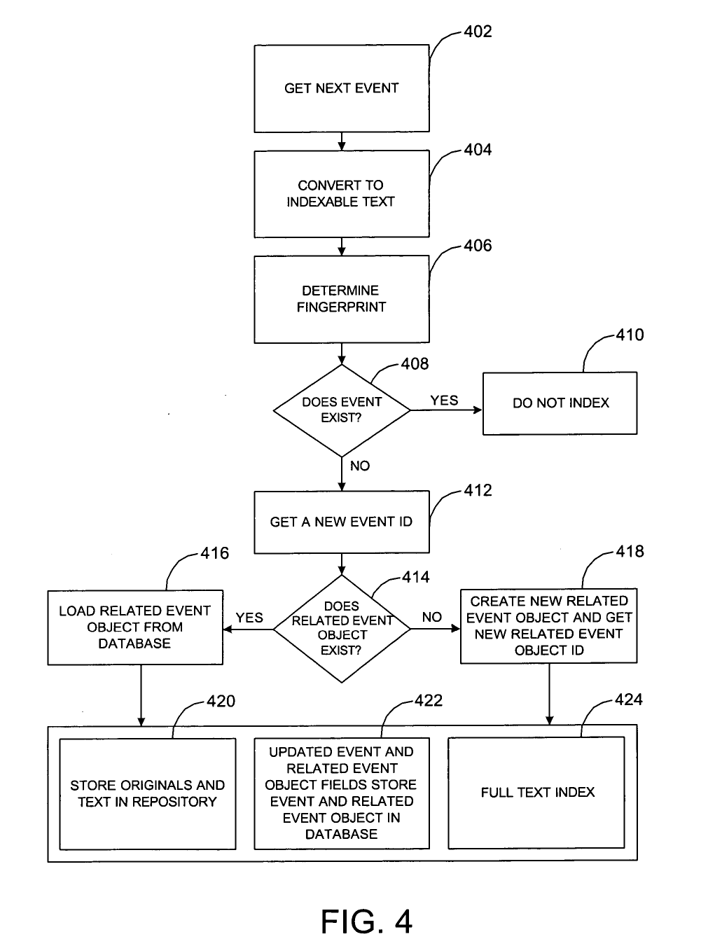

It should be noted that other embodiments of the present invention may comprise systems having different architecture than that which is shown in FIG. 1. For example, in some other embodiments of the present invention, the client device 102a is a stand-alone device and is not coupled to a network. The system 100 shown in FIG. 1 is merely exemplary, and is used to explain the exemplary method shown in FIG. 4.

Various methods in accordance with the present invention may be carried out. For example, in one embodiment, an event associated with an article is captured, wherein the event comprises event data, the event is indexed, a related event object is created related to the event, wherein the related event object comprises a set of one or more related events, and the related event object is associated with the one or more related events. The event can be captured in real-time and indexing the event can occur close in time to capturing the event. The event can be a historical event and indexing the event can be delayed in time after occurrence of the event. In one embodiment, updated event data for the event is received and the updated event data is associated with the event.

In one embodiment, the related event object and at least a portion of the event data can be stored. The related event object is stored at a first location within a data store. At least a portion of the event data can be stored at a second location within the data store. The first location within the data store can comprise a database and the second location within the data store can comprise a repository.

In one embodiment, the article can be associated with a client application and the related event object can comprise a list of different events associated with the article. The article can comprise a web page and the related event object can comprise a list of events comprising accesses to a URL for the web page. The article can comprise an email message and the related event object can comprise a list of events comprising email messages in an email thread. The article can comprise an instant messenger message and the related event object can comprise a list of events comprising instant messenger messages in a conversation. The article can comprise a word processing document and the related event object can comprise a list of events comprising at least some of load, save and print events associated with the word processing file.

In one embodiment, a second level related event object can be created comprising a set of one or more related event objects and a pointer between the second level related event object and the one or more related events objects can be provided. The article can be associated with a client application and the related event object can comprise a list of different events associated with the article, and the second level related event object can comprise a list of related event objects comprising articles associated with the client application associated with a specific directory. The article can comprise a web page and the related event object can comprise accesses to a URL for the web page associated with a website, and the second level related event object can comprise a list of related events objects comprising accesses to URLs associated with the website. The article can comprise an instant messenger message and the related event object can comprise a list of events comprising instant messenger messages in a conversation, and the second level related events object can comprise a list of related event objects comprising instant message conversations associated with a particular user.

In one embodiment, after creating the related event object, at least one second event associated with the article can be captured, the second event can be indexed, it can be determined that the second event relates to the related event object, a pointer between the second event and related event object can be created and the related event object can be updated to record the second event. The at least one second event can comprises a plurality of second events and the steps of capturing, indexing, determining, creating and updating can be serially repeated for each additional second event.

In one embodiment, a search query is received, events relevant to the search query are retrieved, related event objects having related event object data for the relevant events are retrieved, and the relevant events are ranked based at least in part on the event data and the related event object data. In another embodiment, a search query is received, events relevant to the search query are retrieved, related event objects having related event object data for the relevant events are retrieved, and the relevant events are ranked and/or output based at least in part on the event data and the related event object data.

According to one embodiment, a fingerprint of the event data may be computed. The fingerprint may be computed by analyzing text associated with the event and/or by analyzing a location and time associated with the event. The fingerprint may be used to determine if the event is a duplicate event that has already been indexed. The event may not indexed if the event is determined to be a duplicate event and access statistics associated with the related event object are updated.

FIG. 4 illustrates an exemplary method 400 that provides a method for indexing an event and creating or updating a related event object according to one embodiment of the present invention. This exemplary method is provided by way of example, as it will be appreciated from the foregoing description of exemplary embodiments there are a variety of ways to carry out methods in other embodiments of the present invention. The method 400 shown in FIG. 4 can be executed or otherwise performed by any of various systems. The method 400 is described below as carried out by the system 100 shown in FIG. 1 by way of example, and various elements of the system 100 are referenced in explaining the example method of FIG. 4.

In 402, an event from the queue 126 is retrieved by the indexer 130. In one embodiment, the event can be in a format described by an event schema. If the indexer 130 does not have the schema loaded in its schema list, it can construct a schema object to place on the schema list. Once the indexer 130 has both the event and its schema, it can begin to extract the event data associated with the event.

In one embodiment, the indexer 130 determines whether the event is a real-time event or a historical event. In one embodiment, the capture processor 124 can label the event prior to sending it to the queue 126 with a label specifying if the event is an indexable event, a non-indexable event, a historical event, and/or a real-time event. In this embodiment, the indexer 130 can read the label and determine how and when to process the event. If the event is a real-time event, the indexer 130 can process the event right away so that the event can be indexed close in time to the capture and occurrence of the event. Alternatively, if the event is a historical event, the indexer 130 can delay processing the event in favor of any real-time events. In one embodiment, real-time events may be processed by the indexer 130 in small batches and historical events can be processed in larger batches of, for example, 100 events or more. The indexer 130 may also decide not to index (or delay the indexing of) a historical event or events based on event data, such as that the associated article has not been accessed in a period of time, for example, one year. The indexer 130 may also decide not to index (or delay the indexing of) a historical event or events based on performance data associated with the client device, such as available memory.

Each event may be associated with an event type, e.g., email, and an article that has a native format, e.g., HTML. In 404, the article (or content) associated with the event is converted into indexable text. The article associated with the event can already be converted into an indexable format or the indexer 130 can send the article to be converted to an indexable format. In one embodiment, the capture component that captured the event can convert the associated article into indexable text. This can be done, for example, by using the associated client application. For example, for a word processing document event, a word processing application can be used to convert the associated word processing document to indexable text.

In one embodiment, handlers can be used to convert text from the native format in a structured manner, and then produce the actual text to be indexed from the event. A general master class can be defined where handlers are registered to the indexer 130. In one embodiment, for example, there can be two types of master classes. One type of master class can call handlers that can convert from one content type to another, such as, for example, from HTML to text, or from PDF to text. The other type of master class can call event handlers. Event handlers can process the actual content of the event. For example, for a web page event where the native format is HTML, an HTML content handler can be called that can convert the native content to text. A web event handler may then be called to process the fields of the event.

For example, when the indexer 130 receives the following event:

<Event type= “email” name = “email-schema” version “1”
<Subject> how are you? </Subject>
<From>john_smith@network.com </From>
<To>mary_smith@network.com </To>
<Time></Time>
<Encoding>HTML</Encoding>
<NativeContent><html><head> .<p>Are you enjoying the view? </p>
</NativeContent>
<NativeFormat>text/html</NativeFormat>
</Event>

it can first call the appropriate handler to process the native content. The appropriate handler can be retrieved from a Format Master, which can have a map from the content-type to handlers. This handler can produce text for the processed content field, which in this case would be “Are you enjoying the view?”

Next, the indexer 130 can use an event type Master to call the appropriate event type handler for the event, which in the example is email. The email handler, among other things, contains the logic that knows which fields are relevant to index, and can properly produce the actual indexable text, e.g., “how are you?/John_Smith@network.com/ Mary_Smith@network.com/Are you enjoying the view?”

In one embodiment, the event type handlers can include hard coded rules for determining which fields are indexable and can string the indexable fields together into an indexable string. In another embodiment, Boolean attributes can be included in the event schema to indicate to the indexer 130 which event fields are indexable. The indexer 130 can then string together the separate indexable fields to generate a text string. The fields may be marked in the indexable string so that the indexing system can support fielded search (for example, searching for a term in the From: field).

In one embodiment, the event type handlers can include hard coded rules for determining which fields are indexable and can string the indexable fields together into an indexable string. In another embodiment, Boolean attributes can be included in the event schema to indicate to the indexer 130 whether the event is indexable. The indexer 130 can then string together the separate indexable fields to generate a text string.

For HTML files with images, such as web pages, in addition to conversion, the image URL can be extracted for storage in the repository 146. A representative image can be determined for a web page and can be the first member of an annotated list of article images. The representative image can be used in addition to, or instead of, a screenshot taken by the capture component to represent the web page.

In 406, the indexer 130 can determine a fingerprint from the indexable text before indexing that can be used to determine duplicate events. A fingerprint can be the output of a cryptographic hash function (a hash digest) such as MD5, SHA1, etc. These generally aim to be collision-free, meaning that is difficult for the same fingerprint to be generated by two different pieces of data. Thus, when two identical fingerprints are found, the system can assume that the data that generated them was identical. In one embodiment, the fingerprint for the event can be independent of when the event is indexed. For example, the indexer 130 can, prior to indexing the event compute a fingerprint for the event and store the event in a database or table associating the fingerprint with the event. The fingerprint can be computed, for example, from the indexable text and can result in a number. In another embodiment, the fingerprint can be based on a time and location associated with the event.

In 408, the indexer 130 can determine whether the event is a duplicate of an event that has already been indexed. The indexer 130 can use the indexable text of the event to determine if the event is a duplicate of another event. In one embodiment, the indexer 130 can compare the fingerprint determined in 406 for the event to a table of fingerprints for other events and can determine if there are any matches. If a match is determined, the indexer 130 can compare the times of occurrence of the two events. If the times of occurrence match or nearly match, then the event may be a duplicate of the previous event and the indexer 130 can determine if the previous event has been indexed. Other methods known to those skilled in the art can be used to determine duplicate events.

In 410, if indexer 130 determines that the event is a duplicate of a previously indexed event, then the indexer 130 can treat the new event as a duplicate and not index the duplicate event. If the new event is determined to be a duplicate, the indexer 130 can update the access statistics for the associated article and/or a related events object.

In 412, if the database search does not find a duplicate event, the indexer 130 can assign a new Event ID to the current event. The Event ID can be assigned serially.

Each event can have an associated related event object. In 414, the indexer 130 determines if a related event object already exists for the event. The indexer 130 can use a URI, such as, for example, the file name for a word processing document or the URL for a web page to search for an existing related event object. In 416, if an associated related event object is found, the indexer 130 can retrieve the appropriate Related Event Object ID from the database 144. The indexer 130 can also update related event object data, such as last access time and frequency of access.

In 418, if no associated related event object is identified, the indexer can create a new related event object with a new Related Event Object ID. The indexer 130 can also update several database tables to record the creation of the new related event object, such as, for example, content fingerprint, event status, date index, and location index. In one embodiment, for events except email and instant messaging events, the related event object can be determined based on a location associated with the event. For an instant messaging event, the related event object can be determined based on a conversation ID, and for an email event, the related event object can be determined based on the subject of the email message or a conversation ID.

After a related events object ID is associated with the event, the indexer 130 can index and store the event data associated with the event in the data store 140. In 420, the indexer 130 can store the content associated with the event, such as the article, in the repository 146. The indexer 130 can store the article in its indexable format or in its original format or both. The indexer 130 can provide a version number for the article. Any images associated with the event can also be stored in the repository.

In 422, the indexer 130 can store the event and related event object in the database 144. The indexer 130 can update the event to point at its associated related event object and the related event object can be updated to add a link to the event. At least some of the event data associated with the event can be stored in the database 144. In one embodiment, the events are stored without the content data or associated articles, which can be stored in the repository 146.

In 424, the indexer 130 can update the index 142. In one embodiment, the indexer 130 can update the index 142 by making a call to the index 142 with the indexable text and using the Event ID associated with the event. The maximum number of terms that can be indexed can optionally be specified within the index. While the data store is described as having a repository, a database, and an index, various other configurations are possible, such as a single database to store the index and event data, including content, for the event. The data store can be one or more logical or physical storage areas. Various other methods and configurations of storing the events can also be used.

In one embodiment, event data for an event can be updated. For example, for a web page event generated when the user accesses a web page, event data can be updated after the user navigates away from the web page. Updated event data, such as how long the user spent on the web page can be captured and retrieved by the indexer 130. The indexer 130 can then associated the updated event data with the stored event data.

The related events objects can improve the relevance of search results and improve the display of search results. For example, a related events object associated with web page events, for example, can allow for the efficient assessment of statistics, such as the time spent on the associated web page over multiple events, by compiling related event object data. Event data associated with an event and related event object data can be used in ranking associated events in response to a search query. A related events object associated with email message events can allow for the output of details of an entire email message thread on a display device, even though, for example, only one email message in the thread might match a search query.

The systems and methods of the present invention provide for the structuring and storing of events associated with different types of articles such as web pages, email messages, word processing documents, etc. This can allow the events and associated articles to be readily accessed using a search engine or application and can allow a user to perform searches across many different article formats and sizes.

The environment shown reflects a client-side search engine architecture embodiment. Other embodiments are possible, such as a stand-alone client device or a network search engine.

While the above description contains many specifics, these specifics should not be construed as limitations on the scope of the invention, but merely as exemplifications of the disclosed embodiments. Those skilled in the art will envision many other possible variations that are within the scope of the invention.

1. A method, comprising:
capturing an event associated with an article, wherein the event comprises event data;
indexing the event;
creating a related event object related to the event, wherein the related event object comprises a set of one or more related events; and
associating the related event object and the one or more related events.

2. The method of claim 1, further comprising storing the related event object and storing at least a portion of the event data.

3. The method of claim 2, wherein the related event object is stored at a first location within a data store.

4. The method of claim 3, wherein at least a portion of the event data is stored at a second location within the data store.

5. The method of claim 1, wherein the event is captured in real-time and indexing the event occurs close in time to capturing the event.

6. The method of claim 1, wherein the event is a historical event and indexing the event is delayed in time after occurrence of the event.

7. The method of claim 1, wherein the article is associated with a client application and the related event object comprises a list of different events associated with the article.

8. The method of claim 1, wherein the article comprises a web page and the related event object comprises a list of events comprising accesses to a URL for the web page.

9. The method of claim 1, wherein the article comprises an email message and the related event object comprises a list of events comprising email messages in an email thread.

10. The method of claim 1, wherein the article comprises an instant messenger message and the related event object comprises a list of events comprising instant messenger messages in a conversation.

11. The method of claim 1, wherein the article comprises a word processing document and the related event object comprises a list of events comprising at least some of load, save and print events associated with the word processing file.

12. The method of claim 1, further comprising:
creating a second level related event object comprising a set of one or more related event objects; and
providing a pointer between the second level related event object and the one or more related events objects.

13. The method of claim 12, wherein the article is associated with a client application and the related event object comprises a list of different events associated with the article, and the second level related event object comprises a list of related event objects comprising articles associated with the client application associated with a specific directory.

14. The method of claim 12, wherein the article comprises a web page and the related event object comprises accesses to a URL for the web page associated with a website, and the second level related event object comprises a list of related events objects comprising accesses to URLs associated with the website.

15. The method of claim 12, wherein the article comprises an instant messenger message and the related event object comprises a list of events comprising instant messenger messages in a conversation, and the second level related events object comprises a list of related event objects comprising instant message conversations associated with a particular user.

16. The method of claim 3, wherein the first location within the data store comprises a database.

17. The method of claim 4, wherein the second location within the data store comprises a repository.

18. The method of claim 1, further comprising, after creating the related event object:
capturing at least one second event associated with the article;
indexing the second event;
determining that the second event relates to the related event object;
creating a pointer between the second event and related event object; and
updating the related event object to record the second event.

19. The method of claim 18, wherein the at least one second event comprises a plurality of second events, the method further comprising:
serially repeating the steps of capturing, indexing, determining, creating and updating for each additional second event.

20. The method of claim 1, further comprising
receiving a search query;
retrieving events relevant to the search query;
retrieving related event objects having related event object data for the relevant events; and
ranking the relevant events based at least in part on the event data and the related event object data.

21. The method of claim 1, further comprising receiving a search query;
retrieving events relevant to the search query;
retrieving related event objects having related event object data for the relevant events; and
outputting the relevant events based at least in part on the event data and the related event object data.

22. The method of claim 1, further comprising receiving updated event data for the event and associating the updated event data with the event.

23. The method of claim 1, wherein a fingerprint of the event data is computed.

24. The method of claim 23, wherein the fingerprint is computed by analyzing text associated with the event.

25. The method of claim 23, wherein the fingerprint is computed by analyzing a location and time associated with the event.

26. The method of claim 23, wherein the fingerprint is used to determine if the event is a duplicate event that has already been indexed.

27. The method of claim 26, wherein the event is not indexed if the event is determined to be a duplicate event and access statistics associated with the related event object are updated.

28. A computer-readable medium containing program code, comprising:
program code for capturing an event associated with an article, wherein the event comprises event data;
program code for indexing the event;
program code for creating a related event object related to the event, wherein the related event object comprises a set of one or more related events; and
program code for associating the related event object and the one or more related events.

29. The computer-readable medium of claim 28, further comprising program code for storing the related event object and storing at least a portion of the event data.

30. The computer-readable medium of claim 29, wherein the related event object is stored at a first location within a data store.

31. The computer-readable medium of claim 30, wherein at least a portion of the event data is stored at a second location within the data store.

32. The computer-readable medium of claim 28, wherein the event is captured in real-time and indexing the event occurs close in time to capturing the event.

33. The computer-readable medium of claim 28, wherein the event is a historical event and indexing the event is delayed in time after occurrence of the event.

34. The computer-readable medium of claim 28, wherein the article is associated with a client application and the related event object comprises a list of different events associated with the article.

35. The computer-readable medium of claim 28, wherein the article comprises a web page and the related event object comprises a list of events comprising accesses to a URL for the web page.

36. The computer-readable medium of claim 28, wherein the article comprises an email message and the related event object comprises a list of events comprising email messages in an email thread.

37. The computer-readable medium of claim 28, wherein the article comprises an instant messenger message and the related event object comprises a list of events comprising instant messenger messages in a conversation.

38. The computer-readable medium of claim 28, wherein the article comprises a word processing document and the related event object comprises a list of events comprising at least some of load, save and print events associated with the word processing file.

39. The computer-readable medium of claim 28, further comprising:
program code for creating a second level related event object comprising a set of one or more related event objects; and
program code for providing a pointer between the second level related event object and the one or more related events objects.

40. The computer-readable medium of claim 39, wherein the article is associated with a client application and the related event object comprises a list of different events associated with the article, and the second level related event object comprises a list of related event objects comprising articles associated with the client application associated with a specific directory.

41. The computer-readable medium of claim 39, wherein the article comprises a web page and the related event object comprises accesses to a URL for the web page associated with a website, and the second level related event object comprises a list of related events objects comprising accesses to URLs associated with the website.

42. The computer-readable medium of claim 39, wherein the article comprises an instant messenger message and the related event object comprises a list of events comprising instant messenger messages in a conversation, and the second level related events object comprises a list of related event objects comprising instant message conversations associated with a particular user.

43. The computer-readable medium of claim 30, wherein the first location within the data store comprises a database.

44. The computer-readable medium of claim 31, wherein the second location within the data store comprises a repository.

45. The computer-readable medium of claim 28, further comprising, after creating the related event object:
program code for capturing at least one second event associated with the article;
program code for indexing the second event;
program code for determining that the second event relates to the related event object;
program code for creating a pointer between the second event and related event object; and
program code for updating the related event object to record the second event.

46. The computer-readable medium of claim 45, wherein the at least one second event comprises a plurality of second events, further comprising:
program code for serially repeating the steps of capturing, indexing, determining, creating and updating for each additional second event.

47. The computer-readable medium of claim 28, further comprising program code for receiving a search query;
program code for retrieving events relevant to the search query;
program code for retrieving related event objects having related event object data for the relevant events; and
program code for ranking the relevant events based at least in part on the event data and the related event object data.

48. The computer-readable medium of claim 28, further comprising
program code for receiving a search query;
program code for retrieving events relevant to the search query;
program code for retrieving related event objects having related event object data for the relevant events; and
program code for outputting the relevant events based at least in part on the event data and the related event object data.

49. The computer-readable medium of claim 28, further comprising program code for receiving updated event data for the event and associating the updated event data with the event.

50. The computer-readable medium of claim 28, wherein a fingerprint of the event data is computed.

51. The computer-readable medium of claim 50, wherein the fingerprint is computed by analyzing text associated with the event.

52. The computer-readable medium of claim 50, wherein the fingerprint is computed by analyzing a location and time associated with the event.

53. The computer-readable medium of claim 50, wherein the fingerprint is used to determine if the event is a duplicate event that has already been indexed.

54. The computer-readable medium of claim 53, wherein the event is not indexed if the event is determined to be a duplicate event and access statistics associated with the related event object are updated.

55. A method, comprising:
capturing an event associated with an article, wherein the event comprises event data;
indexing the event;
creating a related event object related to the event, the related event object comprising a set of one or more related events;
providing a pointer between the related event object and the one or more related events;
creating a second level related events object comprising a set of one or more related event objects; and
providing a pointer between the second level related event object and the one or more related events objects; and
storing the related event object and at least a portion of the event data.
